(19) United States
(12) Patent Application Publication
(10) Pub. No.: US 2019/0041222 A1
(43) Pub. Date: Feb. 7, 2019

(54) FULL WIDTH CROSS VEHICLE DISPLAY

(71) Applicant: FORD GLOBAL TECHNOLOGIES, LLC, Dearborn, MI (US)

(72) Inventors: Balbir S. Grewal, Ann Arbor, MI (US); Loren John Lohmeyer, III, Monroe, MI (US); Robert R. Hoveland, Plymouth, MI (US)

(21) Appl. No.: 15/668,369

(22) Filed: Aug. 3, 2017

(51) Int. Cl. G01C 21/26; B60K 37/06; B60K 37/02

(52) U.S. Cl. CPC G01C 21/265; B60K 37/06; B60K 37/02; B60K 2350/1076; B60K 2350/1064; B60K 2350/1072; B60K 2350/2013; B60K 2350/1004

(57) ABSTRACT

A motor vehicle display includes a display screen having a first end adjacent a first A-pillar and a second end adjacent a second A-pillar of the motor vehicle. A related method of displaying information in a motor vehicle is also disclosed.

### TECHNICAL FIELD

This document relates generally to the motor vehicle equipment field and, more particularly, to a motor vehicle display having a display screen that extends across the full width of the motor vehicle at the bottom or base of the windshield and across the top of the instrument panel.

### BACKGROUND

It is common in today's motor vehicles to display information on many different screens. Such screens may be located in the instrument panel, at the center stack, along the console surface or even in the interior or exterior rearview mirrors. The display areas are relatively small and often complex sometimes even requiring the operator to press an actuator for the screen itself to select between displays of different information. Significantly, looking and controlling the various display screens may be a distraction for some drivers.

This document relates to a new and improved motor vehicle display that extends completely across the width of the motor vehicle at the base of the windshield and along the top of the dashboard adjacent a first A-pillar on one side of the motor vehicle to adjacent a second A-pillar on the other side of the motor vehicle. The display screen meets down vision requirements and despite its position, does not degrade defrost airflow and in some applications actually improves the airflow pattern for better defrost performance.

Advantageously, the motor vehicle display is designed to facilitate assembly and service while also offering many extraordinary benefits to the driver and passenger. The motor vehicle display eliminates the need for a center stack display thereby eliminating the need for the driver to turn his or her head to view such a display. Advantageously, the display screen also effectively functions as a Heads Up Display (HUD) requiring minimal distraction from the operation of the vehicle. Advantageously, navigation may also be displayed in the vision zone of the driver in a large, readily discernible presentation thereby eliminating the need to look down or across the vehicle to see a small map as presently required by center stack located navigation displays in current state of the art motor vehicles.

In some embodiments, the motor vehicle display may be configured to display live video from rearwardly directed cameras providing views equivalent to the standard interior and/or exterior rearview mirrors of a state of the art motor vehicle. Motor vehicles equipped with such a motor vehicle display will not require actual interior and exterior rearview mirrors and as such may be characterized by a more aesthetically pleasing appearance and more effective aerodynamic shape.

### SUMMARY

In accordance with the purposes and benefits described herein, a new and improved motor vehicle display is provided. That motor vehicle display comprises a display screen having a first end adjacent a first A-pillar and a second end adjacent a second A-pillar of the motor vehicle. For purposes of this document, the term adjacent may mean within 10 cm of the A-pillar, within 7 cm of the A-pillar, within 5 cm of the A-pillar, within 3 cm of the A-pillar and abutting the A-pillar. Advantageously, the display screen extends fully across the width of the motor vehicle at the base of the windshield along the top of the instrument panel while meeting any down vision requirements to allow the operator to properly drive the motor vehicle.

The display screen may have a display side to display an image and a back side opposite the display. The back side is oriented toward the windshield. Still further, the motor vehicle display may include a plurality of external ribs supporting the display screen along the back side. That plurality of external ribs may be configured as airflow vanes to direct airflow from an HVAC system of the motor vehicle between the display screen and the windshield of the motor vehicle.

A blackout may be provided on the bottom portion of the windshield to conceal the back side of the display screen and the plurality of external ribs. Such a blackout improves the aesthetic appearance of the vehicle when viewed from the front.

The motor vehicle display may further include a controller operatively connected to the display screen and configured to control the display of information on the display screen. Further, the motor vehicle display may include a first rearview side camera and a second rearview side camera connected to the controller. In addition, the controller may be configured to display a first image from the first rearview side camera on the side of the display screen adjacent the first A-pillar. Further, the controller may be configured to display a second image from the second rearview side camera on the side of the display screen adjacent the second A-pillar.

In some embodiments, the motor vehicle display screen may comprise a liquid crystal display. Further, in some embodiments the display screen may be a single liquid crystal display while in other embodiments the display screen may comprise a plurality of liquid crystal displays configured together to form a continuous display screen that extends from the first A-pillar to the second A-pillar.

In accordance with an additional aspect, a method is provided of displaying information in a motor vehicle. That method comprises locating a display screen across a top of an instrument panel and a bottom portion or base of the windshield wherein the display screen extends from adjacent a first A-pillar to adjacent a second A-pillar opposite the first A-pillar.

The method may further include the step of displaying, by a controller, a first image from a first rearview side camera on the display screen adjacent the first A-pillar. Further, the method may include the step of displaying, by the controller, a second image from a second rearview side camera on the display screen adjacent the second A-pillar.

Still further, the method may include the step of displaying, by the controller, information from a wireless data network on the display screen. The method may include the step of displaying information from any personal computing device such as a cell phone, a tablet or the like on the display screen. In addition, the method may include the step of displaying, by the controller, operating parameters of the motor vehicle on the display screen.

Still further, the method may include the step of directing conditioned air from an HVAC system of the motor vehicle across the windshield by a plurality of external ribs that support the display screen and that are configured as airflow vanes. Further, the method may include the step of closing out the back side of the display screen and the plurality of external ribs by providing a blackout on the windshield. Further, the method may include the step of maintaining a sight line above the display screen that meets down vision requirements for operating the motor vehicle.

In the following description, there are shown and described several preferred embodiments of the motor vehicle display and the related method of displaying information in a motor vehicle. As it should be realized, the motor vehicle display and related method are capable of other, different embodiments and their several details are capable of modification in various, obvious aspects all without departing from the motor vehicle display and method as set forth and described in the following claims. Accordingly, the drawings and descriptions should be regarded as illustrative in nature and not as restrictive.

### BRIEF DESCRIPTION OF THE DRAWING FIGURES

The accompanying drawing figures incorporated herein and forming a part of the specification, illustrate several aspects of the motor vehicle display and related method and together with the description serve to explain certain principles thereof.

FIG. 1 is a perspective view from the interior of the motor vehicle looking forward toward the motor vehicle display which extends along the base of the windshield and the top of the instrument panel from adjacent a first A-pillar at one side of the motor vehicle to adjacent a second A-pillar at the opposite side of the motor vehicle.

FIG. 2 is a detailed end elevational view from one end of the display screen illustrating one of the external ribs that supports the back side of the display screen.

FIG. 3 is a detailed top plan view illustrating a plurality of five external ribs extending between the back side of the display screen and the windshield and configured as airflow vanes to direct and control the flow of air from the HVAC system of the motor vehicle and facilitate an airflow pattern providing optimum defrost performance based on CFD flow analysis.

FIG. 4 is a detailed schematic illustration of the airflow directed from the defrost register outlet across one of the external ribs onto the windshield through the gap provided between the top of the display screen and the windshield.

FIG. 5 is a schematic block diagram of the control architecture for the motor vehicle display.

Reference will now be made in detail to the present preferred embodiments of the motor vehicle display and related method of displaying information in a motor vehicle, examples of which are illustrated in the accompanying drawing figures.

### DETAILED DESCRIPTION

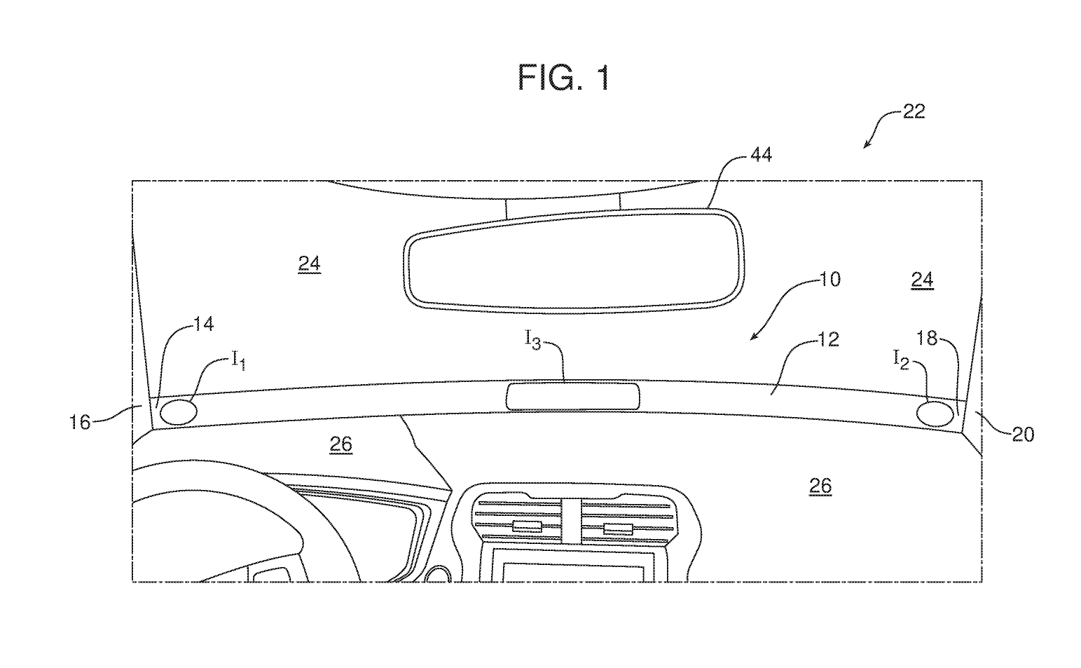

Reference is now made to FIGS. 1-5 illustrating the new and improved motor vehicle display 10. That motor vehicle display 10 includes a display screen 12 having a first end 14 adjacent a first A-pillar 16 and a second end 18 adjacent a second A-pillar 20 of the motor vehicle 22. As illustrated in FIG. 1, the display screen 12 may extend fully across the bottom or base portion of the windshield 24 and the top of the instrument panel 26 the full width across the motor vehicle from the first A-pillar 16 to the second A-pillar 20. In such an embodiment, the two A-pillars 16, 20 may provide structural support for the display screen 12. In alternative embodiments, the display screen 12 may extend to within approximately ten, seven, five or three centimeters of the first A-pillar 16 and the second A-pillar 20 with the small space between the first end 14 of the display screen 12 and the first A-pillar 16 and the small space between the second end 18 of the display screen and the second A-pillar filled by a decorative closeout trim panel or a structural support feature.

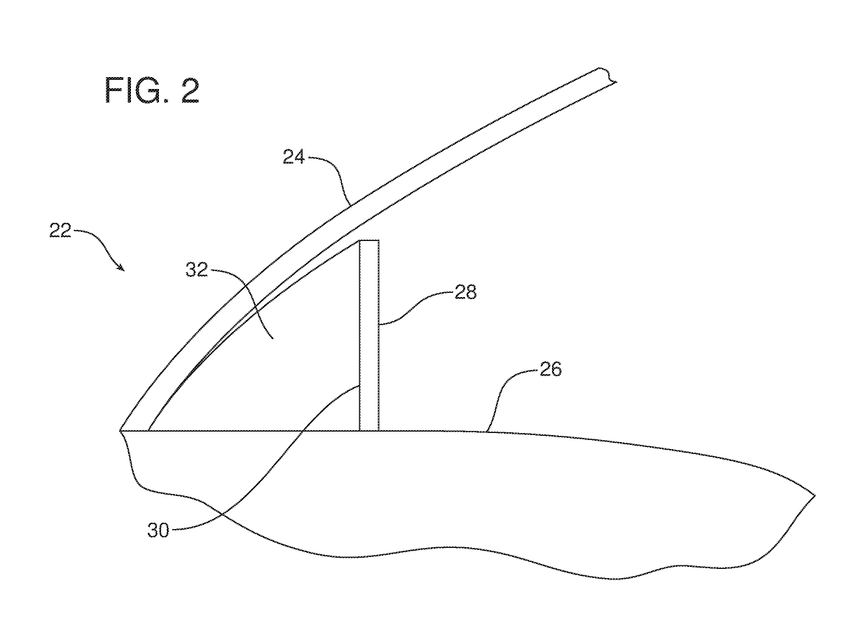

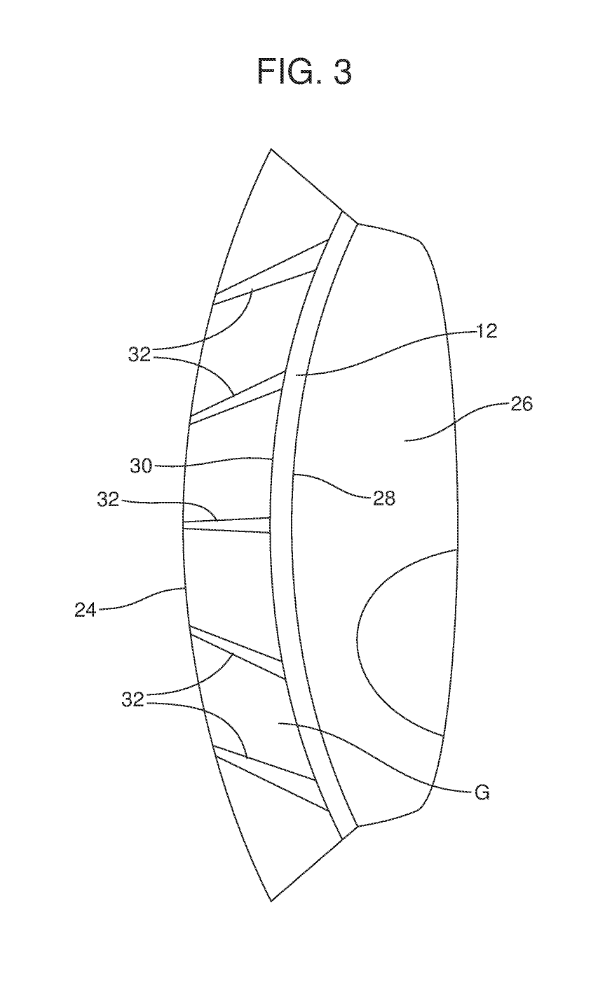

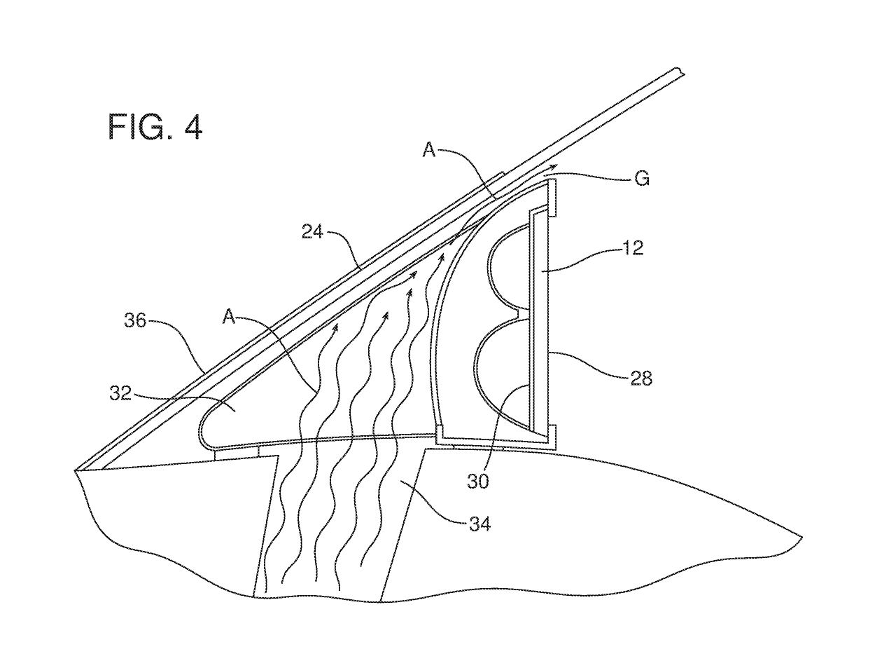

As best illustrated in FIGS. 2-4, the display screen 12 has a display side 28 directed away from the windshield 24 toward the occupants of the motor vehicle 22 and adapted to display an image for viewing. In addition, the display screen 12 includes a back side 30 oriented motor vehicle forward toward the windshield 24 and opposite the display side 28. A plurality of external ribs 32 support the display screen 12 along the back side 30. As best illustrated in FIGS. 3 and 4, the plurality of external ribs 32 are configured as airflow vanes and are adapted to direct airflow from an HVAC system of the motor vehicle and, more particularly from the defrost register outlet 34 between the display screen 12 and the windshield 24 of the motor vehicle. Note action arrows A showing the airstream passing through the gap G maintained at the top of the display screen 12 between the display screen and the windshield 24.

As should also be appreciated from reviewing FIG. 4, a blackout 36 may be provided along the bottom portion of the windshield 24 in order to conceal the back side 30 of the display screen 12 and the external ribs 32 from view. This improves the aesthetic appearance of the motor vehicle when viewed from the front or front quarter of the motor vehicle.

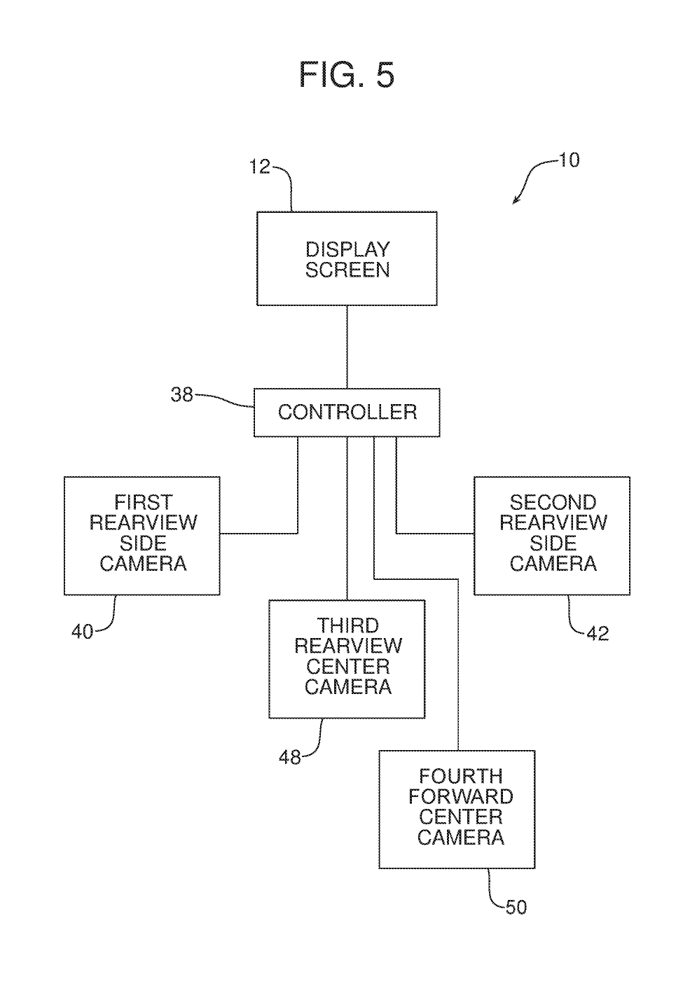

As illustrated in FIG. 5, the motor vehicle display 10 may also include a controller 38 operatively connected to the display screen 12 and configured to control the display of information on the display screen. That controller 38 may comprise a computing device such as a dedicated microprocessor or an electronic control unit (ECU) operating in accordance with instructions from appropriate control software. Thus, the controller 38 may comprise one or more processors, one or more memories and one or more network interfaces all in communication with each other over a communication bus.

In some embodiments the controller 38 may comprise a body control module or BCM having one or more processors, one or more memories, one or more network interfaces, a human interface, a GPS/Geo Locator component, and a speech processor that all communicate with each other over a communication bus. As is known in the art, a body control module or BCM performs a number of interior body electrically based functions including, for example, interior locking, remote key entry, interior lighting, exterior lighting, windshield wiper control and the like. In some embodiments, the body control module or BCM may also function to control entertainment functions (e.g. radio, CD player) and communications such as telephone and internet communications over a wireless network. In some embodiments, the body control module or BCM may be connected by a communication bus (not shown) to other control modules that provide one or more of these additional functions. Advantageously, the speech processor would allow the controller 38 to respond to voice commands from the motor vehicle operator or other occupants of the motor vehicle if desired.

As further illustrated in FIG. 5, the motor vehicle display 10 may also include a first rearview side camera 40 and a second rearview side camera 42 connected to the controller 38. More specifically, the first rearview side camera 40 would provide a rearview commonly associated with an exterior driver's side rearview mirror while the second rearview side camera 42 would provide a rearview commonly associated with an external passenger side rearview mirror.

In some embodiments or applications, the controller 38 may be configured to display a first image I₁ from the first rearview side camera 40 on the display side 28 of the display screen 12 adjacent the first end 14 and first A-pillar 16. See FIG. 2. Similarly, the controller 38 may also be configured to display a second image I₂ from the second rearview side camera 42 on the display side 28 of the display screen 12 at the second end 18 adjacent the second A-pillar 20. In such an embodiment, actual driver's side and passenger side exterior rearview mirrors may be omitted from the motor vehicle to improve the aesthetic appearance and aerodynamic performance of the motor vehicle while at the same time providing the necessary rearview images to allow safe operation of the motor vehicle. Here it should be noted that the first image I₁ and second image I₂ are located at positions where a driver is conditioned to find them: that is near where the exterior rearview mirrors would normally be located.

The display screen 12 may comprise a single display extending all the way across the motor vehicle 22 at the base of the windshield 24 along the top of the instrument panel 26 or a plurality of displays that are configured together to form a continuous display screen extending from the first A-pillar 16 to the second A-pillar 20. In one possible embodiment, the display screen 12 is a liquid crystal display. It should be appreciated, however, that the display screen 12 may comprise other known technologies or even technologies to be developed in the future which are suitable for the intended purpose. Thus, the display screen 12 may be an organic light emitting diode (OLED) based display, a light emitting diode (LED) based display or a plasma display panel (PDP).

Consistent with the above description, a method is provided of displaying information in a motor vehicle 22. That method may be broadly described as comprising the steps of locating the display screen 12 across the top of the instrument panel 26 and along the bottom portion of the windshield 24 so that the display screen extends from adjacent the first A-pillar 16 to adjacent the second A-pillar 20.

The method may also include the step of displaying, by the controller 38, the first image I₁ from the first rearview side camera 40 on the display screen 12 adjacent the first A-pillar 16. Similarly, the method may include the step of displaying, by the controller 38, the second image I₂ from the second rearview side camera 42 on the display screen 12 adjacent the second A-pillar 20.

In addition, the method may include the step of displaying, by the controller 38, information from a wireless data network, such as the internet, on the display screen 12. Data or information from substantially any other computing device, such as a smart phone, a lap top computer or a tablet computing device may also be displayed on the display screen 12. Still further the method may include the step of displaying, by the controller 38, operating parameters of the motor vehicle on the display screen 12. Those operating parameters may include but are not necessarily limited to the speed of the motor vehicle, the revolutions per minute of the engine of the motor vehicle, the mileage of the motor vehicle, the oil pressure of the motor vehicle, the fuel level of the motor vehicle, the oil temperature of the motor vehicle, the coolant temperature of the motor vehicle, the operating status of the HVAC system of the motor vehicle, the operating status of the transmission of the motor vehicle, the operating status of the turn indicators of the motor vehicle, one or more warning lights respecting operating conditions of the motor vehicle and the like.

In addition, the method may include displaying, by the controller 38, other information of interest to the motor vehicle operator including, for example, navigation system data, directions to a desired location, the remaining travel range of the motor vehicle, telephone numbers, wireless messages, video or other streaming data or the like.

Still further, the method may include the step of directing conditioned air from the HVAC system of the motor vehicle 22 across the windshield 24 by means of a plurality of external ribs 32 that support the display screen 12 and are configured as airflow vanes. This is illustrated by the action arrows A in FIG. 4.

Further, the method may include the step of closing out the back side 30 and the external ribs 32 by providing the blackout 36 along the bottom portion or base of the windshield 24. See FIG. 4.

Still further, the method may include the step of maintaining a good sight line above the display screen 12 through the windshield 24 wherein that sight line meets down vision requirements for safely and efficiently operating the motor vehicle 22.

The foregoing has been presented for purposes of illustration and description. It is not intended to be exhaustive or to limit the embodiments to the precise form disclosed. Obvious modifications and variations are possible in light of the above teachings. For example, the motor vehicle display 10 may further include a third rearview center camera 48 configured to provide a livestream video image consistent with the view commonly associated with the interior rearview mirror of a motor vehicle. The controller 38 may be further configured to display this third image I₃ from the third rearview center camera 48 at the center of the display screen 12 where a driver is conditioned to find such a rearview image. See FIG. 1. In such an embodiment, the interior rearview mirror 44 may be removed from a motor vehicle in order to provide a more aesthetically pleasing and uncluttered interior along the windshield 24.

The controller 38 may also be configured to display a fourth image (not shown) from a fourth forward center camera 50 configured to provide a livestream video image forward of the motor vehicle. Further, the controller 38 may be connected with a series of video cameras configured to provide a 360° view around the motor vehicle for display on the display screen. Such a view is particularly beneficial when parking the motor vehicle in a tight area. All such modifications and variations are within the scope of the appended claims when interpreted in accordance with the breadth to which they are fairly, legally and equitably entitled.

What is claimed:

1. A motor vehicle display, comprising:
a display screen having a first end adjacent a first A-pillar and a second end adjacent a second A-pillar of a motor vehicle.

2. The motor vehicle display of claim 1, wherein said display screen has a display side to display an image and a back side opposite said display side.

3. The motor vehicle display of claim 2, further including a plurality of external ribs supporting said display screen along said back side.

4. The motor vehicle display of claim 3, wherein said plurality of external ribs are configured as airflow vanes to direct airflow from an HVAC system between said display screen and a windshield of said motor vehicle.

5. The motor vehicle display of claim 4, wherein said display screen extends along a top of an instrument panel and across a bottom portion of said windshield.

6. The motor vehicle display of claim 5, wherein a black-out is provided on said bottom portion of said windshield to conceal said back side and said plurality of external ribs.

7. The motor vehicle display of claim 6, further including a controller operatively connected to said display screen and configured to control display of information on said display screen.

8. The motor vehicle display of claim 7, further including a first rearview side camera and a second rearview side camera connected to said controller.

9. The motor vehicle display of claim 8, wherein said controller is configured to display a first image from said first rearview side camera on said display side adjacent said first A-pillar.

10. The motor vehicle display of claim 9, wherein said controller is configured to display a second image from said second rearview side camera on said display side adjacent said second A-pillar.

11. The motor vehicle display of claim 10, wherein said display screen is a liquid crystal display.

12. The motor vehicle display of claim 10, wherein said display screen is a plurality of liquid crystal displays configured together to form a continuous display screen extending from said first A-pillar to said second A-pillar.

13. A method of displaying information in a motor vehicle, comprising:
locating a display screen across a top of an instrument panel and a bottom portion of a windshield wherein said display screen extends from adjacent a first A-pillar to adjacent a second, opposite A-pillar.

14. The method of claim 13, including displaying, by a controller, a first image from a first rearview side camera on said display screen adjacent said first A-pillar.

15. The method of claim 14, including displaying, by said controller, a second image from a second rearview side camera on said display screen adjacent said second A-pillar.

16. The method of claim 15, including displaying, by said controller, information from a wireless data network on said display screen.

17. The method of claim 16, including displaying, by said controller, operating parameters of said motor vehicle on said display screen.

18. The method of claim 17, including directing conditioned air from an HVAC system of said motor vehicle across the windshield by a plurality of external ribs supporting said display screen and configured as airflow vanes.

19. The method of claim 18, including closing out a back side of said display screen and said plurality of external ribs by providing a blackout on said windshield.

20. The method of claim 19, including maintaining a sight line above said display screen that meets down vision requirements for operating said motor vehicle.
